(19) United States
(12) Patent Application Publication
(10) Pub. No.: US 2003/0038515 A1
(43) Pub. Date: Feb. 27, 2003

(54) Adjustable split bicycle seat

(76) Inventors: Judy Martin, Peshastin, WA (US); Robert Martin, Peshastin, WA (US)

Correspondence Address: GREENBERG & LIEBERMAN, 314 PHILADELPHIA AVE., TAKOMA PARK, MD, 20912, US

(21) Appl. No.: 10/064,858

(22) Filed: Aug. 23, 2002

Related U.S. Application Data
(60) Provisional application No. 60/314,362, filed on Aug. 23, 2001.

(51) Int. Cl. B62J 1/00

(52) U.S. Cl. 297/195.1

(57) ABSTRACT

A split bicycle seat with two mirroring halves. The split seat has a first and second horizontal adjustment plate to allow the user to adjust either the nose or rear of the seat easily and to any desired width from 0″ to ¾″ in the front to 0 to 1 ½″ in the rear. The present invention has two seat mounting bars to easily adhere it to a conventional bicycle.

### BACKGROUND OF INVENTION

The present invention is a bicycle seat that may be adjusted for user's comfort, more specifically it is a bicycle seat having two halves, and two adjustments one at the front and one at the rear of the seat for widening or narrowing the space between the two halves.

Many people enjoy cycling as a hobby, a means of exercise or a means of transportation. There are bicycling trails in metropolitan and rural areas, including revitalization projects for unused railroad tracks to become biking trails in the United States. With rising gasoline prices, and growing environmental concerns, many people are looking to alternative modes of transportation for their daily lives.

There are many different kinds of bicycles on the market designed for different types of riders, racing, mountain, double-seated, children's bicycles with training wheels.

There are also articles of clothing available specifically for cyclists designed to increase aerodynamic capabilities, and comfort. Also each type of bicycle comes with a different type of seat, some of which have padding, some of which are adjustable, and some of which that are wider than others.

There is a double saddle seat available through The Bicycle Planet, http://www.thebicycleplanet.com. J B Two Corporation's double saddle seat is unlike the present invention because it is not shaped so that it is wider in the back than in the front, it does not have horizontal adjustments in the front and rear of the seat to allow for horizontal or vertical adjustments.

U.S. Pat. No. 6,142,562 issued to Varan, on Nov. 7, 2000 exhibits a Bicycle seat. Varan's invention is unlike the present invention because it is not a seat that can adjust but rather a mounting for a seat that can be adjusted, it does not exhibit a seat having two halves, and two adjustments. Also, it does not exhibit a seat that has a space in the center to allow for horizontal widening or narrowing of the seat.

U.S. Pat. No. 6,139,098 issued to Carrillo on Oct. 31, 2000 exhibits a Bicycle Seat. Carrillo's invention is unlike the present invention because it does not have two horizontal halves that can be adjusted to position the seat in a more narrow or wide position. Additionally, it does not have two adjustment spaces on the seat itself for adjusting the seat in a horizontal or vertical manner on either the front or back of the seat.

U.S. Pat. No. 6,116,683 issued to Maier on Sep. 12, 2000 exhibits a Bicycle Touring Seat. Maier's invention is unlike the present invention because it does not have two horizontal halves that separate in a horizontal manner to allow for comfort. It also does not have two adjustment points in the front and back of the seat to adjust the seat in a horizontal or vertical manner.

U.S. Pat. No. 6,113,184 issued to Barnes on Sep. 5, 2000 shows a Bicycle Seat Assembly. Barnes' invention is unlike the present invention because it has an indentation in the front for the scrotum of male riders, but does not have two horizontal halves that can be adjusted at two pivot points for widening or tightening the gap between the halves. It also does not have two adjustment points at the front and rear to allow the rider to adjust the seat in the front or back or both in a horizontal or vertical manner.

U.S. Pat. No. 6,019,422 issued to Taormino, et al. on Feb. 1, 2000 shows a Laterally pivoting bicycle saddle mount with shock absorber. Taormino's invention is unlike the present invention because it does not have two halves that can be adjusted to allow the seat to be wider or more narrow for rider comfort Taormino's invention does not allow for horizontal adjustment of the seat in any manner, but rather only allows the rider to adjust the vertical angle of seat on the one pivot point.

U.S. Pat. No. 5,927,802 issued to Kesinger on Jul. 27, 1999 exhibits a bicycle seat having flexible suspension platform for supporting buttocks of a cyclist. Kesinger's invention is unlike the present invention because it does not have two horizontal halves, it does not provide for vertical and horizontal adjustment of the seat, and it does not have a front and rear pivot point for adjustment as does the present invention.

U.S. Pat. No. 5,911,475 issued to Nakahara on Jun. 15, 1999 shows a saddle cover for male riding cyclist. Nakahara's invention is unlike the present invention because it is a seat cover not a seat, it does not provide means for adjusting the seat in a horizontal or vertical fashion, and does not exhibit a seat with two horizontal halves and two pivot points.

U.S. Pat. No. 5,890,760 issued to Kirstein on Apr. 6, 1999 shows a bicycle seat cushion. Kirstein's invention is unlike the present invention because it is a seat cushion only, it does not provide for horizontal or vertical adjustment of the seat and it does not show two horizontal halves of the seat that can widen or narrow the seat.

Therefore a need has been established for a bicycle seat that has two horizontal halves, and can be adjusted in a horizontal or vertical fashion to allow for rider comfort.

### SUMMARY OF INVENTION

The present invention is a bicycle seat having two halves with a horizontal adjustable turnbuckle in the front section and rear section of the seat. The two halves of the present invention mirror each other and are contoured for comfort in long rides. The present invention has two horizontal adjustable turnbuckles that allow the two halves of the present invention to be touching each other at the connection points or as much as ¾″ or 1 ½″ from each other in either the front or the back of the seat, respectively. The first horizontal adjustable turnbuckle may be adjusted for a space of 0″ to ¾″. The second horizontal adjustable turnbuckle may be adjusted for a space of 0″ to 1 ½″. In this manner the user may set the seat at the width most comfortable to themselves. Although there are two horizontal halves of the seat, the present invention is mounted on one seat bar to allow the seat to easily be attached to a conventional bicycle.

The first and second horizontal adjustable turnbuckles can each be positioned at any degree of separation from 0″ to ¾″, or 0 to 1 ½″, respectively, so that the user may set the seat at their desired position. Since the halves are not intended to fit in one another as interlocking pieces even when each of the horizontal adjustable turnbuckles is set at 0″ there is still a small space between the halves in the mid section. The space allows for air circulation for the rider. The seat is designed in an aerodynamic fashion to enable it to be used on racing bicycles without taking away from the speed abilities of these bikes.

### BRIEF DESCRIPTION OF DRAWINGS

FIG. 1 shows the present invention, from the bottom, in a closed position.

FIG. 2 shows the present invention, from the bottom, opened to full capacity.

FIG. 3 shows the present invention, from the bottom, as it attaches to the seat.

### DETAILED DESCRIPTION

The present invention is a adjustable split bicycle seat having two halves of the same size which mirror each other. The adjustable split bicycle seat has a first and a second horizontal adjustable turnbuckle. The first and second adjustable turnbuckles allow the user to widen or narrow the seat in the front or rear, respectively. Each half of the adjustable split bicycle seat has seat rails or mounting bars for removable attachment to a traditional seat mount.

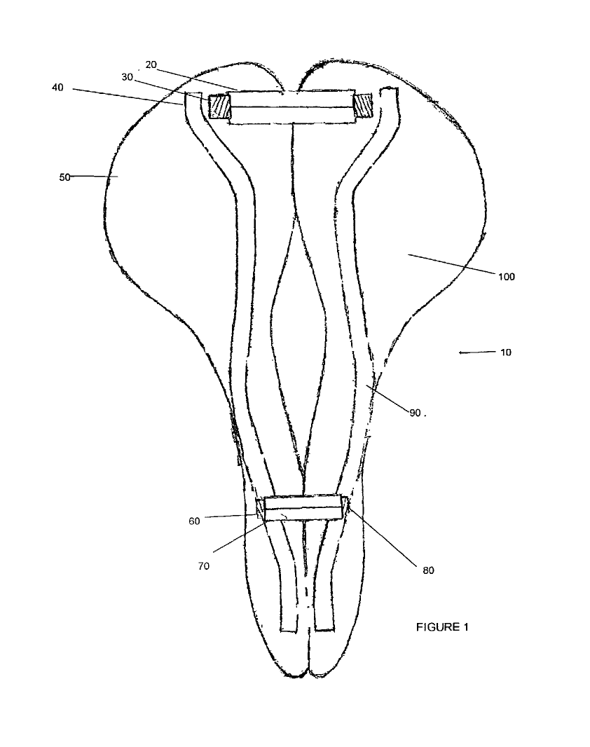

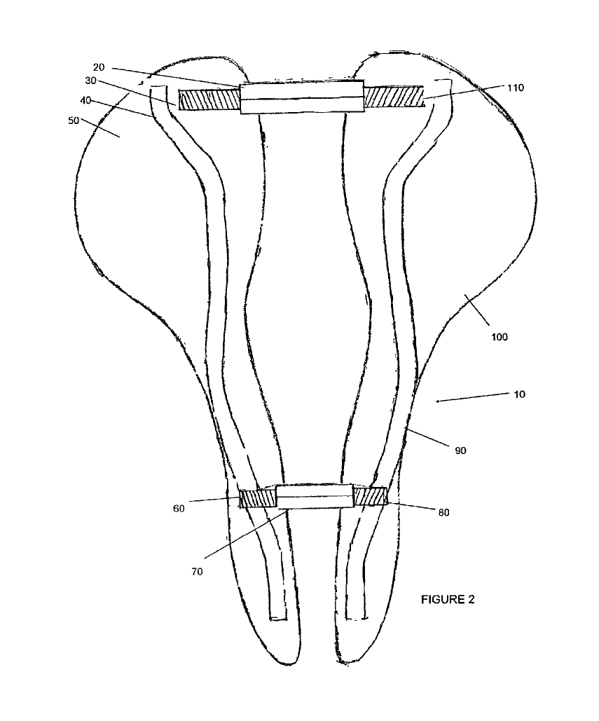

FIG. 1 gives a clear view of the adjustable split bicycle seat (10) from the bottom. The adjustable split bicycle seat (10) has a first half (50) and a second half (100). The first and second halves (50,100) of the adjustable split bicycle seat (10) mirror each other but are not interlocking pieces. The adjustable split bicycle seat (10) is fashioned with an extended length to conventional seats to allow for greater comfort to a female rider. The space between the first and second halves (50,100) allows the user to align the seat to minimize discomfort while riding. The space (FIG. 2) allows a female rider to ride without restriction of blood flow in the veins and nerve bundles around the pelvic bone, by redistributing the weight of the rider to the pelvic bones. The space (FIG. 2) is also advantageous to the male riders as it can leave ample space for the scrotum, without applying pressure to it while riding.

The first horizontal adjustable turnbuckle (70) is placed near to the narrow ends of the halves (50,100). The first horizontal adjustable turnbuckle (70) may be adjusted by first screw (60) and second screw (80), and allows the first and second seat halves to be adjusted horizontally. In the present embodiment of the adjustable split bicycle seat (10) the first and second horizontal adjustable turnbuckles (70,20) are shown in closed position allowing no space between the first half (50) and the second half (100).

The second horizontal adjustable turnbuckle (20) may be adjusted by rolling the turnbuckle moving the third screw (30) and fourth screw (110). The first and second horizontal adjustable turnbuckles (70,20) are each expanded in the same manner. Expansion for the first adjustment of the seat is achieved by the user rolling the adjustable turnbuckle (70) to expose more of each screw (60,80) as is shown clearly in FIG. 2. The second adjustment is expanded by rolling the second turnbuckle (20) to expose more of each screw (30,110) as in FIG. 2. The first, second, third and fourth screws (60,80,30,110) as well as the adjustable turnbuckles (70,20) may be of any conventional design, and are rust proof.

Turning to FIG. 2, there is a clear view of the adjustable split bicycle seat (10) with the first and second horizontal adjustable turnbuckles (70,20) at fully extended position. The first adjustable turnbuckle (70) is expanded to a ¾″ space between the first half (50) and the second half (100) at the nose of the adjustable split bicycle seat (10). The second horizontal adjustable turnbuckle (20) is shown at its full expansion of 1½″ between the first half (50) and the second half (100) of the split bicycle seat (10). The spaces of ¾″ and 1½″ are designed to be enough space to allow the average rider no pressure to the nerve bundles, veins, arteries and to allow weight to be shifted to pelvic bones.

Shown in both FIGS. 1 and 2 are the first and second seat rails or mounting bars (40,90). The first and second seat rails or mounting bars (40,90) allow the adjustable split bicycle seat (10) to be mounted on any conventional seat mounting apparatus, by means of clamping the first and second seat rails or mounting bars (40,90). The seat rails or mounting bars (40,90) can be fabricated of any durable rust proof material such as metal alloy, or fiberglass and are light in weight to add to aerodynamic properties. The adjustable split bicycle seat (10) is constructed to fit on any bicycle.

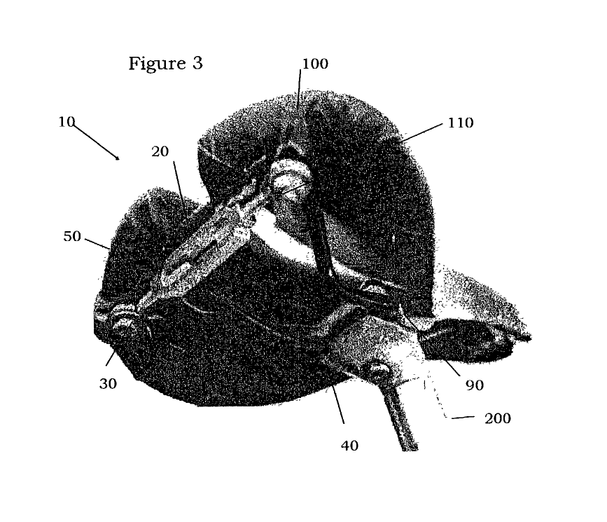

FIG. 3 shows a bottom view of the present invention (10), with the first half (50) and the second half (100) securely, yet removably attached by the seat rails or mounting bars (40,90) to the bicycle extension seat post (200). FIG. 3 also exhibits a clear view of second horizontal adjustable turnbuckle (20), third screw (30), and fourth screw (110) explained in further detail above.

The present invention is not limited to the sole embodiments described above.

1. A seat, comprising:
a first member, having a first forward portion and a first reward portion;
at least one connection member, in communication with said first member;
a second member, having a second forward portion and a second reward portion, in communication with said at least one connection member;
wherein said at least one connection member disposes said first forward portion a desired distance from said second forward portion; and
wherein said at least one connection member disposes said first rearward portion a second desired distance from said second rearward portion.

2. The seat of claim 1, wherein said first member and said second member are asymmetrical halves of the seat.

3. The seat of claim 1, wherein said first member and said second member are contoured to receive a user's buttocks.

4. The seat of claim 2, wherein said first member and said second member are contoured to receive a user's buttocks.

5. The seat of claim 1, wherein said at least one connection member is at least one turnbuckle.

6. The seat of claim 1, wherein said at least one connection member is mounted on a single seat bar.

7. The seat of claim 1, wherein said at least one connection member is at least one rod in combination with at least one bolt.

8. A seat, comprising:
a first member, having a first forward portion and a first reward portion;
a seat rail disposed below said first member;
a second member, having a second forward portion and a second reward portion, in communication with said seat rail;
wherein said seat rail disposes said first forward portion a desired distance from said second forward portion; and
wherein said seat rail disposes said first rearward portion a second desired distance from said second rearward portion.

9. The seat of claim 8, further comprising a seat rail disposed below said first member and said second member.

10. The seat of claim 8, wherein said seat rail is generally “U” shaped, such that the bottom of the “U” shape is under said first rearward portion and said second rearward portion.

11. The seat of claim 9, wherein said seat rail is bifurcated, such that a first portion of said seat rail is disposed under said first member, and a second portion of said seat rail is disposed under said second member.

12. The seat of claim 11, wherein said first portion of said seat rail is joined to said second portion of said seat rail via at least one turnbuckle in combination with at least two screws.

13. The seat of claim 1, wherein said first member and said second member, when brought close together by said at least one connection member, do not interlock, but have an airflow space in between them.

14. The seat of claim 8, wherein said first member and said second member, when brought close together by said seat rail, do not interlock, but have an airflow space in between them.

15. The seat of claim 1, wherein said first reward portion is wider than said first forward portion.

16. The seat of claim 1, wherein said second reward portion is wider than said second forward portion.

17. The seat of claim 8, wherein said first reward portion is wider than said first forward portion.

18. The seat of claim 8, wherein said second reward portion is wider than said second forward portion.

19. The seat of claim 1, wherein said first member is disposed in a different horizontal plane than said second member.

20. The seat of claim 8, wherein said first member is disposed in a different horizontal plane than said second member.
